(19) United States
(12) Patent Application Publication
(10) Pub. No.: US 2026/0126676 A1
(43) Pub. Date: May 7, 2026

(54) PHOTONIC FILTER

(71) Applicant: Telefonaktiebolaget LM Ericsson (publ), Stockholm (SE)

(72) Inventors: Claudio PORZI, Pisa (IT); Antonella BOGONI, Pisa (IT); Fabio CAVALIERE, Pisa (IT)

(21) Appl. No.: 19/114,632

(22) PCT Filed: Oct. 2, 2023
(86) PCT No.: PCT/EP2023/077282

§ 371 Date: Mar. 24, 2025

Related U.S. Application Data
(60) Provisional application No. 63/411,804, filed on Sep. 30, 2022.

(51) Int. Cl. G02F 1/01; G02B 6/12

(52) U.S. Cl. CPC G02F 1/0147; G02B 6/12007; G02F 1/011; G02B 2006/1204; G02F 2201/16; G02F 2201/58; G02F 2203/15; G02F 2203/56

(57) ABSTRACT

A microwave photonic filter, MWP filter, for bandpass filtering. The MWP filter includes a distributed feedback resonator structure comprising a first resonant cavity and a second resonant cavity, wherein the distributed feedback resonator structure is configured such that an input optical signal is filtered by the first resonant cavity and second resonant cavity to generate a filtered output optical signal. The MWP filter further includes a first micro heater configured to adjust the temperature of the first resonant cavity and a second micro heater configured to adjust the temperature of the second resonant cavity. The MWP filter further includes at least one of: a general heater configured to adjust the temperature of the distributed feedback resonator structure; and a tuneable continuous wave laser source, wherein the MWP filter is configured to tune a wavelength of light generated by the tuneable continuous wave laser source and used by the MWP filter.

### TECHNICAL FIELD

Embodiments described herein relate to a photonic filter, in particular a microwave photonic (MWP) filter for passband filtering, a photonic integrated radio frequency (RF) receiver, a radio network node and method for use of the same.

### BACKGROUND

Modern electronic systems utilising transmission and reception, such as mobile and satellite wireless communications and radar sensor systems, typically operate over multiple bands, covering a wide range of frequencies extending from few GHz up to the millimeter-wave and sub-THz bands. As the carrier frequency increases, larger bandwidth is available for high-throughput and low-latency services, with single channel bandwidth that can be as wide as hundreds of megahertz, as in the Frequency Range two (FR2) of 3^{rd} Generation Partnership Project (3GPP) 5^{th} Generation (5G) New Radio (NR) standard, or even few GHz as in the Institute of Electrical and Electronic Engineers (IEEE) 802.11ad standard for networks operating at 60 GHZ (available at https://www.techstreet.com/ieee/standards/ieee-802-11ad-2012?product_id=1820568 as of 27 Sept. 2022). Ultra-wideband antennas, covering bandwidths as large has 100 GHz are also available. In this context, widely tunable and bandwidth reconfigurable RF bandpass filters are desirable for enhancing flexibility of wideband receivers.

Standard Radio Frequency (RF) filtering techniques based on coupled resonators typically provide limited tuning of the filter's central frequency and bandwidth. Accordingly, digitally-switched filter banks are typically used for increasing the range of covered bands. Microwave photonic (MWP) filters, in which the RF signal is upconverted to an optical signal and processed in the optical domain can overcome this limitation, thanks to the ultra-wide band availability at optical frequencies and the large reconfiguration capability of optical systems. These features make MWP filters promising candidates for performing wideband analog front-end processors, allowing the use of filters banks and/or high-speed analog-to-digital converters to be avoided. To practically deploy MWP filtering approaches in real systems, photonic integration provides the key advantages of reduced size, weight, and power consumption, an improved stability, and the possibility of reducing per unit fabrication costs through high-volume production. However, existing MWP bandpass filters have presented limited performance and/or a low integration levels.

Discrete-element RF filters may provide high precision and small size, but typically only allow operation up to about 10 GHz, limited by the availability and tolerance of components with small capacitance and inductance values and moderate dissipative losses. Waveguide cavity filters may facilitate higher frequency values, at the expense of dimensions, weight, and costs, an issue that can be alleviated using ceramic-loaded resonators. However, tuning of the central frequency is constrained to within the specific designed band of operation, and bandwidth reconfigurability is typically limited to few percent of the filter's nominal central frequency. Planar filters, typically realized with microstrip topology, offer the most compact layout, and may be tuned and reconfigured using either analog or digital control signals, but are most suitable for low-to-mid frequency applications due to large losses at high frequencies. The central frequency tunability of planar filters may be improved through the use of filter banks and switches, with tuning resolution limited by the number of control digits. Although this approach allows also for reconfiguring the filter bandwidth, the allowed bandwidth tuning range of few hundreds of MHz makes this approach more suitable for programmable Intermediate Filtering (IF) filtering.

Photonics-based processing of microwave signals has highlighted the possibility of broadband tuning and reconfigurable operation. Existing photonic integrated solutions typically concentrate on implementing the optical core processor (typically, a photonic integrated filter) in waveguide technology, while leveraging on additional bulk optics components for complete system demonstration. For instance, up-conversion to the optical domain of the RF signal to be processed is typically performed using external electro-optic (EO) modulators, either because the performance of photonic integrated devices is not yet as mature as that of commercial devices, or because high-speed EO effect is not supported by the platform providing the high-performing integrated optical filter processor.

The bandwidth reconfigurability of MWP filters based on photonic integrated frequency comb sources may be realized through expensive equipment in liquid crystal on silicon technology; this may hinder cost-effective utilization of the device in practical applications. Frequency tuning and bandwidth reconfigurability of a bandpass optical filter (OF) realized in III-V semiconductor (InP) technology has been reported in “Programmable Photonic Microwave Filters Monolithically Integrated in InP-InGaAsP” by Norberg, E. J. et al, Journal of Lightwave Technology V. 29, No. 11, Jun. 1 2011, Pg 1611 to 1619,in which a cascade of un-coupled resonators and interferometers is used. The cascade of un-coupled stages reduces the extinction and the roll-off of the OF compared for instance with coupled microring resonators (MRRs) architectures, but simplifies the bandwidth-tuning mechanisms as changing the bandwidth of coupled MRRs requires tunable coupling elements; accordingly the filter design, control, and implementation complexity is increased. The integrated OF has been employed to realize a programmable MWP filter using an off-chip EO modulator, but reduction in the optical/microwave filters rejection is observed as the passband width is changed from the optimal condition.

### SUMMARY

It is an aim of the present disclosure to provide high-performance integrated MWP filtering with widely tuneable central frequency and bandwidth. Embodiments may support on-chip integration of several functional elements for improved system miniaturization with a simple and compact layout. Embodiments may provide system applications of the proposed MWP filter for realizing flexible RF downconversion. An example in accordance with embodiments provides a photonic integrated circuit realized in complementary metal-oxide-semiconductor (CMOS) compatible silicon on insulator (SOI) technology.

The present invention is defined in the independent claims, to which reference is now directed.

Embodiments of the present disclosure provide microwave photonic (MWP) filters for bandpass filtering. A MWP filter comprises a distributed feedback resonator structure comprising a first resonant cavity and a second resonant cavity, wherein the distributed feedback resonator structure is configured such that an input optical signal is filtered by the first resonant cavity and second resonant cavity to generate a filtered output optical signal. The MWP filter further comprises a first micro heater configured to adjust the temperature of the first resonant cavity and a second micro heater configured to adjust the temperature of the second resonant cavity. The MWP filter also comprises at least one of: a general heater configured to adjust the temperature of the distributed feedback resonator structure; and a tuneable continuous wave laser source, wherein the MWP filter is configured to tune a wavelength of light generated by the continuous wave laser source and used by the MWP filter.

Further embodiments provide photonic integrated RF receivers comprising MWP filters and radio network nodes comprising photonic integrated RF receivers, optionally wherein a composite signal is converted to a filtered IF signal.

Still further embodiments provide methods for bandpass filtering using a MWP filter. A method comprises tuning a bandwidth of the MWP filter by adjusting the temperature of a first resonant cavity of a distributed feedback resonator structure using a first micro heater. The method also comprises adjusting the temperature of a second resonant cavity of the distributed feedback resonator structure using a second micro heater. The method further comprises tuning the central frequency of the MWP filter by adjusting the temperature of the distributed feedback resonator structure using a general heater and/or tuning the central frequency of the MWP filter by tuning the wavelength of light generated by a tuneable continuous wave laser source and used by the MWP filter. The method may further comprise receiving a RF signal, and upconverting the RF signal into an optical signal, and filtering the optical signal using the tuned MWP filter.

### BRIEF DESCRIPTION OF DRAWINGS

The present disclosure is described, by way of example only, with reference to the following figures, in which:

FIG. 1A and FIG. 1B are schematic diagrams of MWP filters in accordance with embodiments;

FIG. 1C is a flowchart showing methods in accordance with embodiments;

FIG. 1D is a further schematic showing the operation of a tuneable and bandwidth reconfigurable MWP filter in accordance with embodiments;

FIG. 2 is a schematic layout diagram of a photonic integrated reconfigurable OF realized with a distributed feedback resonator (DFBR) structure using SOI technology, in accordance with embodiments;

FIG. 3 is a plot showing an example of Bragg grating mirror (BGM) spectral reflectivity for and same variation of the waveguide effective index between alternate periods and three different number of periods in the structure, in accordance with embodiments;

FIG. 4 is a plot showing an example of a simulated response for a DFBR designed to exhibit a passband window with a −3 dB bandwidth of 500 MHz when tuned in proximity of the Bragg wavelength;

FIG. 5 is a plot showing the calculated spectral response when the resonances of the multi-cavity filter are tuned through the local MHs to resonate away from the Bragg wavelength;

FIG. 6 is a plot showing broader bandwidth reconfiguration than that of FIG. 4 and FIG. 5;

FIG. 7 is a plot showing synthesized passband filter responses for the three considered tuning settings of FIG. 4, FIG. 5 and FIG. 6;

FIG. 8 and FIG. 9 are plots that show results obtained from an example MWP filter in accordance with embodiments;

FIG. 10 is a plot that shows results relative to the tuning of the integrated MWP filter central frequency over a nearly 70 GHz range with 7.5 GHz steps and a MWP filter passband width of about 5 GHz;

FIG. 11 is a plot that shows the results of experimental tuning of the central frequency over a nearly 70 GHz range and two different MWP filter passband widths of about 7.5 and 10 GHZ;

FIG. 12 is a plot showing adjustment of transmission characteristics of the MWP filter;

FIG. 13 is a plot illustrating the possibility of independent central wavelength and bandwidth tuning for the DFBR OF provided by the micro heaters and general heater tuning mechanisms;

FIG. 14 is a plot showing the results obtained from a DFBR optical filter design allowing continuous bandwidth tuning between about 1 and 3 GHZ;

FIG. 15 is a schematic of a wideband RF receiver in accordance with embodiments; and

FIG. 16 is a schematic of a radio network node in accordance with some embodiments.

### DETAILED DESCRIPTION

For the purpose of explanation, details are set forth in the following description in order to provide a thorough understanding of the embodiments disclosed. It will be apparent, however, to those skilled in the art that the embodiments may be implemented without these specific details or with an equivalent arrangement.

Embodiments provide programmable MWP filters that may present flat-top passband functionality with abrupt roll-off and large out-of-band power rejection (OBPR), thereby supporting separation of signal frequencies from undesired signal frequency components (or frequencies from other undesired signals) or from noise frequencies. Embodiments may provide wide tunability of the central frequency and the bandwidth of filters without significantly affecting performance. In an exemplary embodiment, more than 40 dB of OBPR and a tuning range of 70 GHz with only moderate degradation of the rejection capability for filter tuning above about 50 GHz are provided. Embodiments support bandwidth tuning from 5 to 10 GHz, with the possibility of tailoring different minimum/maximum bandwidth values. On-chip optical up-conversion and processing of the RF signal through a high performance OF and a tuneable actuator is provided for the input RF signal, for a high level of functional integration within a compact layout of the order of few squared millimetres.

Embodiments exploit optical-to-RF mapping of a tuneable and bandwidth programmable high-performance OF through a modulation sideband produced by an electro-optical phase modulator, driven by the RF signal to be processed and accepting an optical carrier at proper detuning from the OF at its input. The scanning sideband is then recombined with a replica of the optical carrier to produce the filtered RF signal through the beating in a high-speed photodiode (PD). By acting on the detuning between the OF and the optical carrier and controlling the OF bandwidth, the width and central frequency of the integrated MWP filter can be continuously adjusted. In some embodiments, the bandwidth programmability of the OF is obtained without introducing additional tuning elements with respect to those required for tuning its central frequency if the carrier-to-OF detuning is controlled by changing the laser wavelength (for instance, using simple thermal-or current-controlled tuning of a cost-effective distributed feedback (DFB) laser source). Additionally or alternatively, a single additional heater control can be employed to change the relative detuning between the OF and a fixed optical carrier from the laser source for a given bandwidth configuration setting of the filter. Filters in accordance with embodiments may be integrated with different platforms, including CMOS-compatible silicon-on-insulator (SOI) technology that would enable low-cost high-volume production of the circuit, or the emerging lithium niobate on insulator (LNOI) technology, offering high system linearity and high-speed EO effect for wide operating frequency ranges.

MWP filters in accordance with embodiments support flexible front-end processing of broadband RF data signals, and are therefore suitable for emerging mobile and satellite wireless communication or radar sensor systems operating over multiple bands. By providing a large tuning range for both filter central frequency and filter passband width, while also providing flat-top passband shape, filter selectivity, and out-of-band rejection, embodiments overcome the limitations of current electronics-based solutions in terms of tuning range and bandwidth programmability thus avoiding the use of filter banks for the realization of multiple-band RF receivers. Embodiments may be implemented within an ultra-compact photonic integrated circuit, thereby offering a high miniaturization level, improved stability, and the possibility to reduce the fabrication costs with respect to other MWP filters based on bulk-optics components.

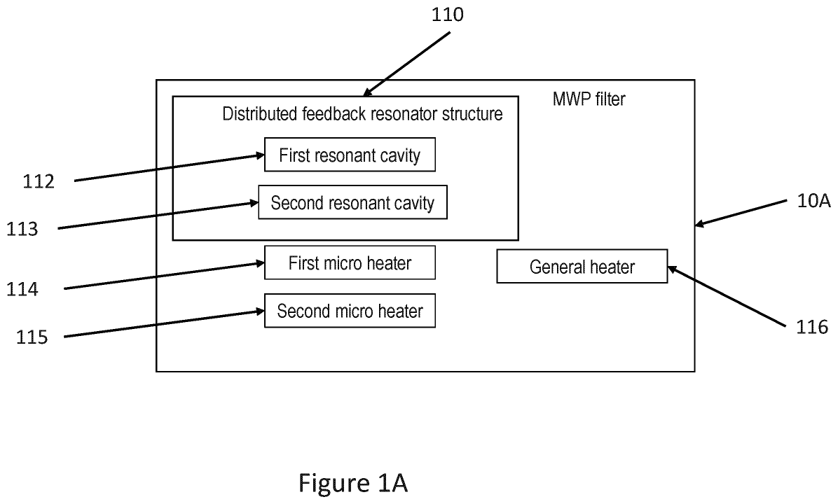

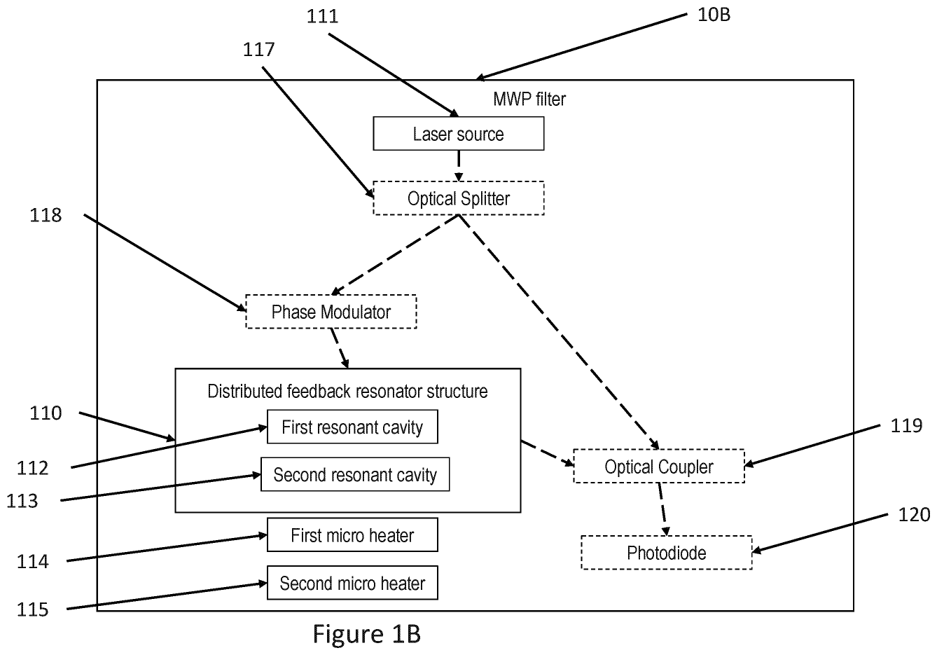

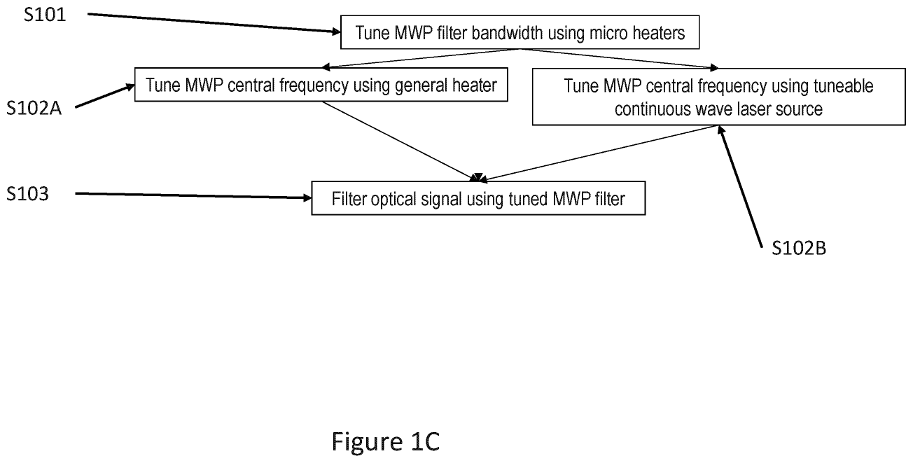

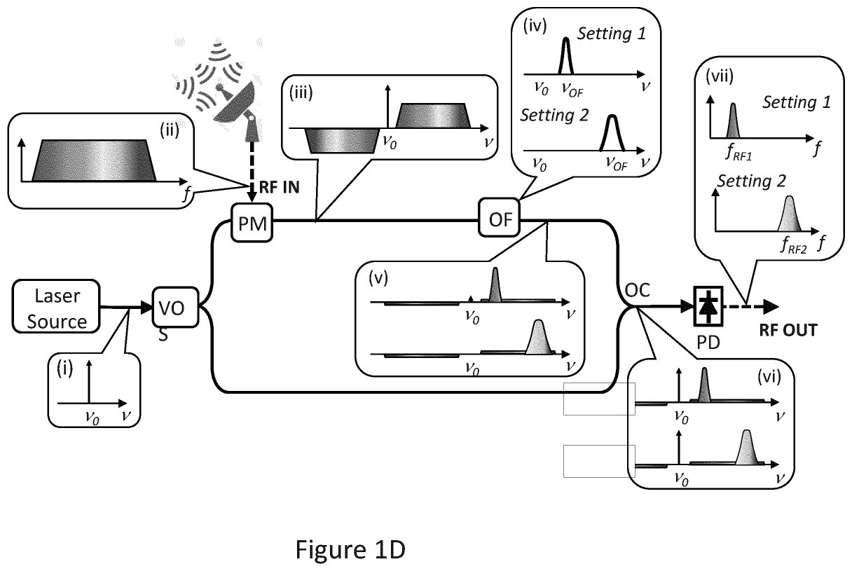

FIG. 1A and FIG. 1B both show schematic diagrams of MWP filters in accordance with embodiments. The MWP of FIG. 1A and FIG. 1B differ in the means by which the central frequency of the MWP filter is tuned. Both the FIG. 1A MWP filter 10A and the FIG. 1B MWP filter 10B comprise distributed feedback resonator structures 110. The distributed feedback resonator structures 110 both comprise resonant cavities. In the embodiments shown in FIG. 1, a first resonant cavity 112 and a second resonant cavity 113 are shown; in other embodiments using either means to tune the central frequency of the MWP filter there may be smaller numbers of resonant cavities (that is, a single resonant cavity), or larger numbers of resonant cavities (for example, six resonant cavities), typically each of which has a corresponding micro heater that is used to adjust the temperature of the resonant cavity. Typically the resonant cavities are each embedded between Bragg grating mirrors. In FIG. 1, a first micro heater 114 is used to adjust the temperature of the first resonant cavity and a second micro heater 115 is used to adjust the temperature of the second resonant cavity. Where plural resonant cavities are present, the cavities are typically arranged in series, with the order of the MWP filter determined by the total number of resonant cavities. Higher order MWP filters (having larger numbers of resonant cavities) typically provide improved filtering performance, particularly in terms of the flat top and steep edge features of the filter. A distributed feedback resonator structure comprises a given number of resonant cavities embedded between partially reflective (typically Bragg grating) mirrors; the distributed feedback resonator structure is configured such that an input optical signal is let through if its wavelength components resonate within the cavities or is blocked if not, to generate a filtered output optical signal.

As shown in FIG. 1A, some embodiments further comprise a general heater 116, which may be used to adjust the temperature of the distributed feedback resonator structure (including the first and second resonant cavities). Additionally or alternatively, and as shown in FIG. 1B, some embodiments comprise a tuneable continuous wave laser source 111. The general heater and/or the tuneable continuous wave laser source may be used to tune the central frequency of the MWP filter. The schematic diagram of FIG. 1B also shows further components that may be included in MWP filters in accordance with embodiments, including an optical splitter 117, phase modulator 119, optical coupler 119 and photodiode 120.

FIG. 1C shows methods that may be used to tune the bandwidth and central frequency of the MWP filter in accordance with embodiments; the MWP filters as shown schematically in FIG. 1A and FIG. 1B may be used in conjunction with the methods of FIG. 1C, or other MWP filters may be used.

As shown in step S101, in order to tune MWP filters, the filter bandwidth may be adjusted using the micro heaters. The micro heaters are individually controlled to adjust the temperatures of specific resonant cavities. By adjusting the temperature of the resonant cavities (in particular by adjusting the temperature of the cavity interior), the filter bandwidth can be tailored/shifted. A secondary effect of this bandwidth adjustment is a change in the central frequency of the MWP filter. Subsequently, the MWP filter central bandwidth can be tuned as shown in steps S102A and S102B; this tuning may compensate for the secondary effects of step S101 and/or may include further adjustments. As shown in step S102A the MWP filter central frequency tuning may be effected by using a general heater to adjust the temperature of the distributed feedback resonator structure as a whole, including both the resonant cavities and other components such as partially reflective mirrors. Additionally or alternatively (and as shown in step S102B), the change in the central frequency may be altered by tuning the wavelength of a tuneable continuous wave laser source used by the MWP filter. Once the MWP filter has been tuned (that is, once any adjustments to the bandwidth and central frequency of the passband have been made), the MWP filter is then used to filter an optical signal as shown in step S103.

MWP filters in accordance with embodiments exploit the optical-to-RF mapping of a passband optical filter (OF) that is sampled by a scanning sideband from an electro-optical (EO) modulator which is subsequently recoupled with the original optical carrier at the modulator input. The beating within a high-speed photodiode (PD) between the scanning sideband and the optical carrier allows for reconstructing the passband OF response in the RF domain. Tuning the OF central frequency with respect to the optical carrier frequency allows for tuning the central frequency of the RF filter, whereas changing the bandwidth of the OF results in a corresponding change in the extension of the filtered spectral components in the RF domain.

FIG. 1D is a further schematic showing the operation of a tuneable and bandwidth reconfigurable MWP filter in accordance with embodiments. The output light from a laser source (LS) at the optical frequency v₀ (i) is sent to a variable optical splitter (VOS), where it is separated into two paths. The relative magnitude of the output light in the two paths may be adjusted to assist in the suppression of noise/unwanted frequencies. On the upper path in FIG. 1D, an EO phase modulator (PM) up-converts to the optical domain the broadband RF signal from a receiving antenna (ii). At the modulator output, two sideband replicas of the RF spectrum are created at positive and negative frequencies around v₀ (iii). A following passband OF having a central frequency v_{OF} which is properly detuned from v₀ (iv) selects a portion of either the upper or lower sideband, while strongly suppressing all the other spectral components (v). Two possible settings for the passband OF, involving the tuning of both its bandwidth and central frequency are illustrated in FIG. 1D. After the OF, the selected portion of the optical spectrum is re-coupled with the laser carrier emerging from the other branch of the VOS (vi) through an optical coupler (OC). The composite signal at the output of the OC is then routed to a PD that down-converts back to the RF domain the selected portion in the sideband spectrum corresponding to a given setting of the OF (vii). By acting on the VOS, the relative amplitude between the reinserted carrier and the scanning sideband impinging on the PD can be finely adjusted, which allows fine optimization of the integrated MWP filter performance.

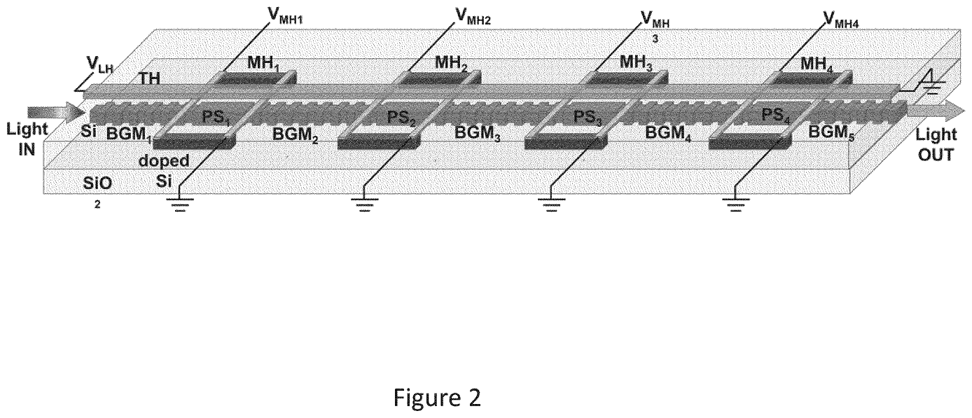

FIG. 2 is a schematic layout diagram of a photonic integrated reconfigurable OF realized with a distributed feedback resonator (DFBR) structure using SOI technology, in accordance with embodiments. The use of a distributed feedback resonator structure allows for designing narrow passband transfer functions within a wide stopband region up to several hundreds of GHz, as required for wideband processing of RF signals, within a compact wire-like geometry. This simplifies the filter design with respect to weakly-coupled micro ring resonator (MRR) structures, for which designing a narrow passband requires also reducing the free-spectral-range of the filter (FSR), i.e., the frequency separation between adjacent passband peaks, that is typically limited to within few tens of GHz. The FSR-to-passband trade-off is even more stringent for the case of tuneable-bandwidth coupled-MRRs OFs, due to the finite length of the tuneable coupler that bounds the minimum MRR length (hence the maximum FSR). On the other hand, DFBR structures allows for a simple bandwidth-tuning mechanism for the optical passband with no, or limited, added complexity.

In the embodiment shown schematically in FIG. 2, a 4th-order multi-cavity filter is realized by embedding four phase shift (PS) sections between five symmetric Bragg grating mirrors (BGMs) realized in a laterally corrugated silicon strip waveguide (that is, four resonant cavities). With proper length of the BGMs (i.e., the number of corrugation periods), a passband window within a stop-band region defined by the bandwidth of the gratings can be shaped in the filter spectral transmission. Any arbitrary filter order, defining the flatness and steepness of the passband response for a given bandwidth, can be designed with proper number of PS sections and BGMs. As discussed previously, the resonances of the coupled cavities can be adjusted through local micro heaters (MHs) that control the optical path of each PS section. By acting on the MHs it is thus possible to tune the passband window within the filter stopband region (which is defined by the reflection spectrum of the Bragg grating mirrors), without affecting its edges. As shown in the figure, the MHs can be for instance realized using resistive doped silicon stripes symmetrically placed from the sidewalls of the PS sections. The micro heaters may be controlled using separate input voltages from one another. In some embodiments, as also shown in FIG. 2, a long metal general heater (here referred to as a top heater, TH), covering the whole length of the structure, is deposited above the oxide cladding in correspondence of the silicon strip waveguide. The role of the general heater is to perform a rigid translation of the whole stopband, changing de facto the Bragg wavelength, λ_{b}, of the grating mirrors by increasing the optical length of the corrugation period through thermo-optic effect.

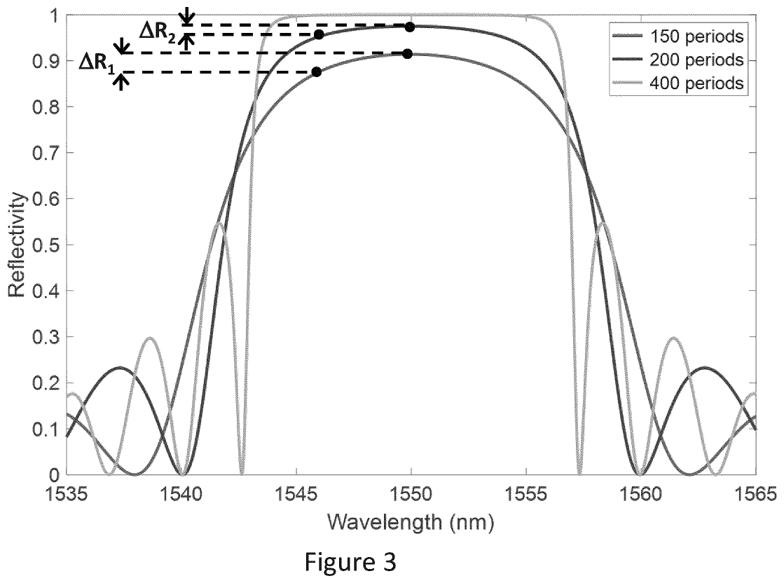

The OF bandwidth tuning mechanism for the considered DFBR structure is then described in detail in the following. When the optical path of the PS sections matches an odd multiple of λ_{b}/4 (i.e., half the corrugation period of the grating), the passband peak lies in the centre of the stopband. In this case, the highest possible quality (Q)-factor is attained for the coupled cavities, since the BGMs reflectivity is maximum at around λ_{b}. Correspondingly, when the passband is tuned in proximity of the centre of the stopband, its width attains a minimum. As the resonant wavelength of the filter is shifted toward the edges of the stopband, the Q-factor of the cavities decreases, due to the roll-off of the grating strength away from λ_{b}. This is illustrated in FIG. 3, where the spectral reflectivity of three different BGMs, each designed to have λ_{b}=1550 nm, are reported. The same level of waveguide corrugation width, that defines the unitary reflection at the interface between two periods, has been considered in the calculations, whereas the number of periods is varied. Within the grating bandwidth (i.e., the region around λ_{b} comprised between the first two reflection nulls), the mirror reflectivity decreases away from the Bragg wavelength, and larger changes in the reflectivity for a given detuning from λ_{b} can be observed for shorter structures (i.e., mirrors with smaller number of periods in the grating), as indicated for the cases of the BGMs with 150 and 200 periods.

FIG. 3 is a plot showing an example of Bragg grating mirror (BGM) spectral reflectivity for same variation of the waveguide effective index between alternate periods and three different number of periods in the structure, in accordance with embodiments. In the high-reflectivity region, the reflectivity decreases away from the Bragg wavelength λ_{b} of 1550. For the case of 150 periods, the change in reflectivity ΔR₁ is larger than the corresponding change ΔR₂ when 200 periods are considered, for the same detuning from λ_{b}. The reflectivity change is even smaller for the 400 periods curve.

As a consequence of the reduced Q-factor of the filter coupled cavities when the resonances of the PS sections are properly detuned from the Bragg wavelength, the produced passband response is consequently wider. This property is thus exploited to realize a bandwidth programmable photonic integrated filter. Larger changes in the passband width can then be attained within the filter stopband by keeping sufficiently low the number of periods in the various BGM embedded in the DFBR. This is advantageous for the sake of extending the bandwidth reconfigurability range of the MWP filter, as well as for minimizing the dissipated power required for tuning the passband window within the stopband region through the MHs, and also for avoiding tuning the passband too close to the stopband edge (since a sufficient wide portion of the stopband should be present at both sides of the passband for guaranteeing the wideband MWP filter operation as illustrated in FIG. 1D, for example). However, as also shown in the plots of FIG. 3, smaller number of periods also corresponds to a weaker BGM reflectivity, which might limit the maximum attainable cavity Q factor, and hence the minimum filter bandwidth. In order to produce DFBR designs with narrow passband widths down to the GHz range or below, while taking advantage the large reflectivity variations associated with a moderate number of BGM periods for the sake of bandwidth reconfigurability, the physical length of the PS sections between adjacent BGMs can be conveniently increased. Longer PS sections increase indeed the photons lifetime in the cavity allowing thus for compensating the reduction of the Q-factor (that represents the ability of the resonator to store photons for longer times) associated with a reduced reflectivity in the BGMs.

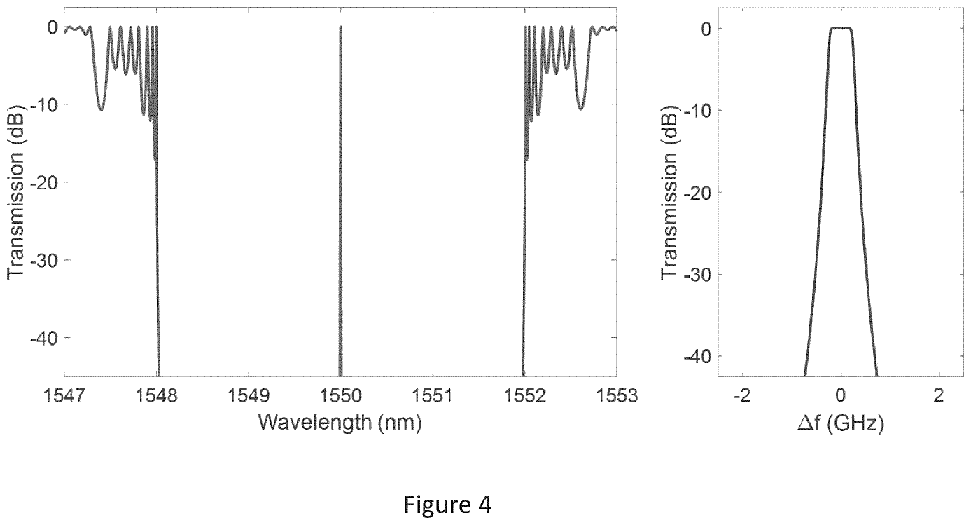

FIG. 4 is a plot showing an example of a simulated response for a DFBR designed to exhibit a passband window with a −3 dB bandwidth of 500 MHz when tuned in proximity of the Bragg wavelength (i.e., the centre of the filter stopband). The left plot in FIG. 4 shows the device response over a wide wavelength span covering the entire filter stopband, while the right plot shows details of the passband window around the peak transmission frequency. For this design, the −3 dB bandwidth of the passband is 500 MHz. The calculated spectral response when the resonances of the multi-cavity filter are tuned through the local MHs to resonate away from the Bragg wavelength is then shown in FIG. 5. Two transmission peaks can now be seen within the filter stopband. This is because the length of the PS sections in this design is such to support two modes within the BGMs bandwidth. In FIG. 5, the simulated DFBR spectral transmission when the coupled cavities resonate away from the Bragg wavelength of the BGMs (1550 nm in the example) is shown. The left plot of FIG. 5 shows the device response over a wide wavelength span covering the entire filter stopband, while the right plot shows details of the passband window that is centred at about 1549 nm. For this design, the −3 dB bandwidth of the passband is 1 GHZ.

The frequency separation between the two peaks is however larger than 300 GHz (about 2.5 nm) which, following the operation scheme of FIG. 1, guarantees a useful tuning range of the MWP filter without spurious RF output components over about a 150 GHz frequency excursion (i.e., maximum detuning between optical carrier and OF corresponding to a carrier wavelength lying slightly below the middle wavelength between the two passband peaks). For this double-resonance filter feature, either the upper-or lower-wavelength passband window can be employed for realizing MWP filter operation, which might facilitate the MWP filter central frequency tuning by minimizing the required wavelength shift of either the optical carrier or of the DFBR Bragg wavelength (as described ahead) for a given bandwidth setting of the passband. In particular, both simplified tuning mechanism and minimized tuning power can be attained by this mean. The shape of the shorter wavelength passband window centred at around 1549 nm has been optimized through the MHs settings for this calculation, and the corresponding details are also displayed in the figure, revealing a −3 dB bandwidth of 1 GHz in this case.

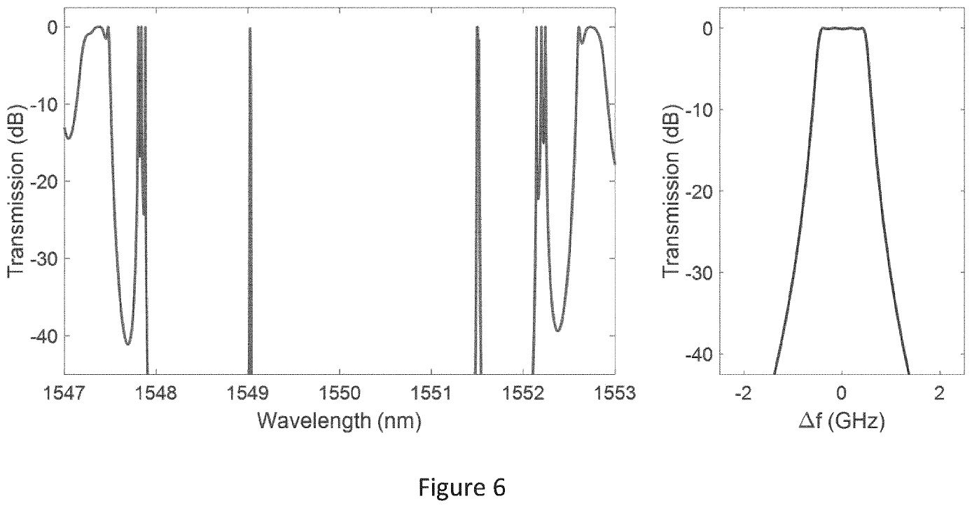

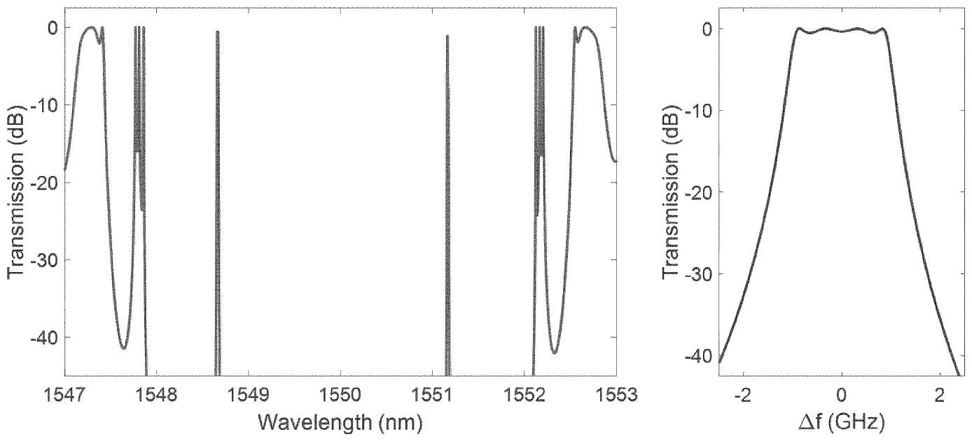

Broader bandwidth reconfiguration than that illustrated by FIG. 4 and FIG. 5 may be obtained by further detuning the lower-(or upper) wavelength passband window central frequency away from the centre of the stopband. This is illustrated in FIG. 6, where the details of the lower-wavelength passband window tuned at 1548.67 nm reveals a −3 dB bandwidth of 2 GHz. In this case, the MWP filter operating frequency range without spurious output signals in the low-frequency tuning regime (i.e., optical carrier wavelength slightly above passband window wavelength) is now limited by the frequency separation between the selected passband and the lower-wavelength edge of the stopband, which is nevertheless 100 GHz for this DFBR design. As the optical carrier is tuned away from the passband window toward the middle of the stopband (or, equivalently, the Bragg wavelength of the DFBR is decreased) the useful spurious-free operating frequency range clearly increases toward the approximate 150 GHz limit set by half the frequency separation between the passband peaks. In FIG. 6, the left plot shows the device response over a wide wavelength span covering the entire filter stopband, while the right plot shows details of the passband window centred at about 1548.67 nm. For this design, the −3 dB bandwidth of the passband is 2 GHZ.

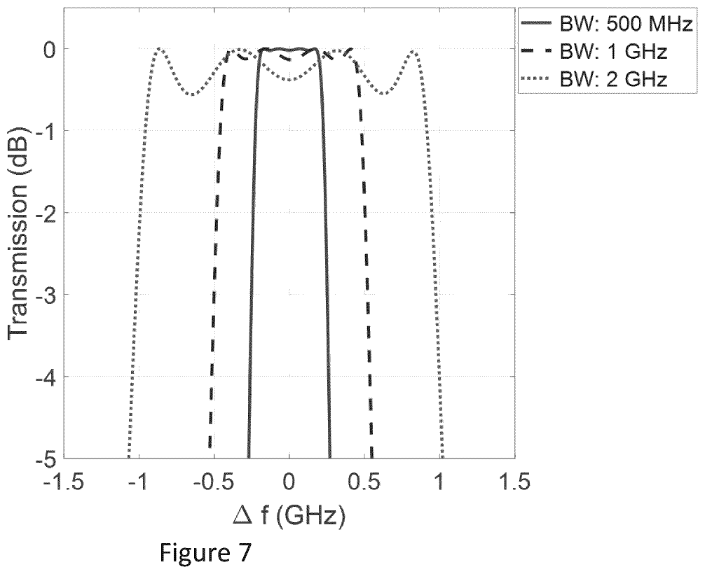

The synthesized passband filter responses for the three considered tuning settings (of FIG. 4, FIG. 5 and FIG. 6) are show in the FIG. 7 plot, where the transfer functions are plotted versus the relative detuning from the central frequency. As described in the operating scheme of FIG. 1, the reconfigurability of the OF bandwidth reflects into variations of the MWP filter when the portion of the modulated sideband at the PM output that is selected by the OF is recoupled with the original optical carrier and delivered to a PD to generate the RF filtered signal at the circuit output. However, as also seen, changing the bandwidth of the DFBR passband transfer function also implies a change in the OF central wavelength. If the reconfiguration of the MWP filter bandwidth would be required without changing its central frequency, an additional shift of either the optical carrier or of the optical passband transfer function (toward opposite directions) would then be required to keep the same relative detuning when passing from one OF bandwidth configuration to the other. Such a wavelength shift (of either the carrier or OF position) is similarly required when the central frequency of the MWP filter has to be changed for a given OF bandwidth setting.

A change in the optical carrier implies tuning the laser source (LS). Without resorting to expensive widely tuneable laser sources, this tuning could be achieved by simply changing the temperature or, alternatively or additionally, the injection current level of the optical source. Since the required shift is expected to be in the order of few nanometres (e.g., below 2 nm) in order to tune the MWP central frequency of up to more than 100 GHz and/or follow the bandpass wavelength variation for different bandwidth settings (see FIG. 4, FIG. 5, and FIG. 6), the afore mentioned mechanisms would suffice to this scope (although lower efficiency may be obtained when using current-based wavelength tuning). In some embodiments these approaches could provide some drawbacks, such as a more complex packaging of the integrated MWP filter, and/or relatively long tuning times due to the settling times associated with photons cavity decay/build-up in narrow linewidth lasers.

Accordingly, some embodiments utilise a general heater, an example of which is shown in the schematic DFBR representation of FIG. 2. While the micro heaters mainly affect the local temperature of the PS sections, the role of the general heater is to induce a general (typically uniform) temperature variation to the entire DFBR structure, including the BGMs. As such, the optical path of the periodic perturbation in the grating structure can be controlled through thermo-optic effect, resulting in a corresponding shift of the Bragg wavelength of the mirrors and thus in a rigid translation of the whole stopband (contrary to micro heater-based tuning that affected the passband position within a nearly fixed-edges stopband). The combination of local micro heaters, acting on the resonances of the coupled cavities, and of the general heater acting on the Bragg wavelength of the BGMs allows thus for the independent tuning of the DFBR passband central wavelength and bandwidth. In this way, assuming positive thermo-optic coefficient (as is the case, for instance, of silicon) producing an increase in the optical path over the corrugation period, the wavelength of the passband windows that are located toward the shorter-wavelength edge of the stopband as in FIG. 5 and FIG. 6 can be properly increased to match that of the passband window located at the stopband centre of FIG. 4. In the MWP filter operation described in FIG. 1, this will result in the possibility of correspondingly changing the RF filter bandwidth while keeping fixed its central frequency without the need for changing the optical carrier wavelength. Alternatively, by applying different control signals to the general heater for given micro heater settings (hence fixed bandwidth) permits to sweep the MWP filter central frequency while keeping fixed the laser source. As mentioned, a combination of the different possible mechanisms for setting the relative detuning between the optical carrier and the OF for a given passband configuration (e.g., general heater tuning and laser wavelength tuning), also under the possibility of multiple-passbands DFBR filter characteristic, and considering that the components from either the left or right optical sideband after the phase modulator (PM) in FIG. 1D can be selected by the optical filter (OF) in the same figure for correct operation, could also be employed for minimizing the tuning complexity and/or power consumption for producing a desired MWP filter response (in terms of both bandwidth and central frequency) in the RF domain.

As an alternative to silicon on insulator (SOI) photonic integrated circuits, other photonic integration such as lithium niobate on insulator (LNOI) may also be used to form the MWP filter. High-quality Bragg-grating-based filter have been demonstrated in LNOI technology, and large-bandwidth, low-voltage linear phase modulators are also available for implementing the scheme of FIG. 1D, with the exception of external laser source and photodiode. For this latter case, the filter tuning may be realized using the high-speed EO effect, and the independent bandwidth and wavelength tuning mechanisms that exploits acting either solely on the PS sections or on the entire DFBR structure would provide an additional improvement in terms of reconfiguration speed in respect to reconfiguring the MWP filter through optical carrier tuning. However it is expected that moderate improvement in tuning speed can also be achieved through thermo-optic effect in silicon waveguides, by avoiding the settling times associated with tuning of narrow-linewidth lasers.

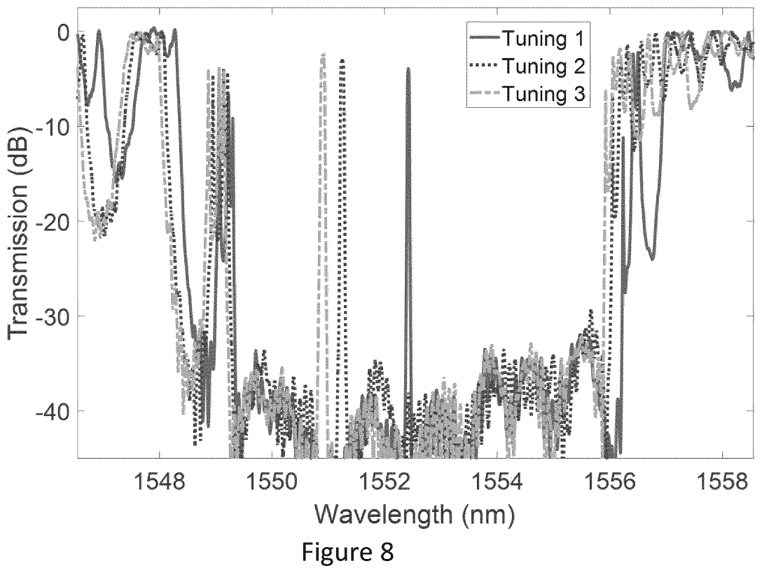

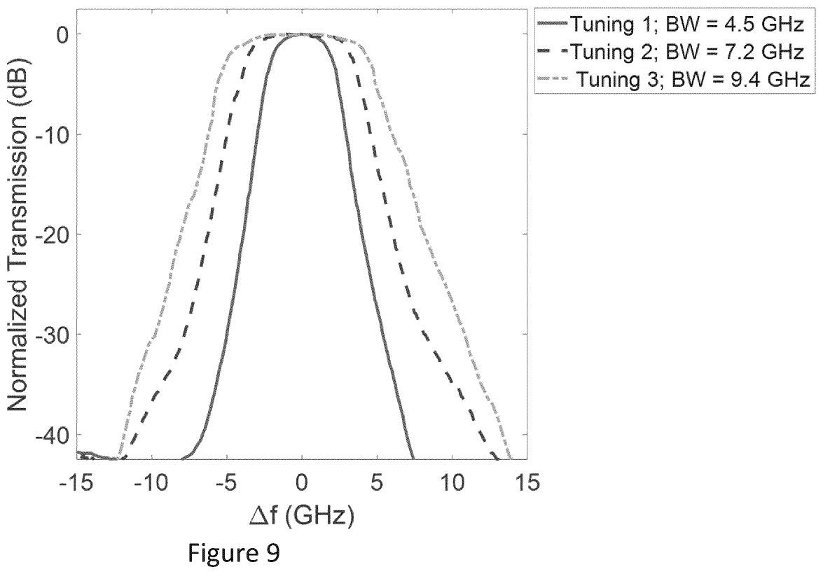

FIG. 8 and FIG. 9 show results obtained from an example MWP filter in accordance with embodiments. The device is based on SOI technology and was formed using deep ultra-violet (DUV) lithography, the MWP filter is in accordance with the schematic diagram of FIG. 1D. The phase modulator is a 2 -mm-long silicon photonics carrier-depletion based device, and the integrated optical filter is implemented in a high-order multi-cavity DFBR architecture as shown in FIG. 2. The variable optical splitter is realized using a symmetric balanced Mach Zehnder interferometer with thermal phase control onto its arms. The output optical coupler is realized with a 2×2 multimode interference (MMI) device, with one output connected to the photonic integrated circuit (PIC) optical output port for subsequent down-conversion to RF domain of the processed optical signal through an external high-speed photodiode. The overall on-chip occupied area, including metal routs and contact pads, is less than 2 mm².

The spectral transmission, and the corresponding details of the passband windows for three different cases of passband tuning within the stopband are shown in FIG. 8 and FIG. 9, respectively, for the example 4th-order DFBR filter. Passband tuning in proximity of the stopband centre (tuning 1 in FIG. 8 and FIG. 9) provides a 3 dB bandwidth of approximately 4.5 GHz, with a sharp roll-off leading to a rejection of nearly 30 dB at a detuning of 5 GHz from the centre of the flat-top region. For the cases named tuning 2 and tuning 3 in FIG. 8, corresponding to an increasingly larger detuning of the passband toward the lower-wavelength side of the stopband, the measured −3 dB bandwidth is about 7.2 and 9.4 GHz, respectively, as reported in FIG. 9. A large out-of-band rejection in excess of 40 dB is preserved also in these cases.

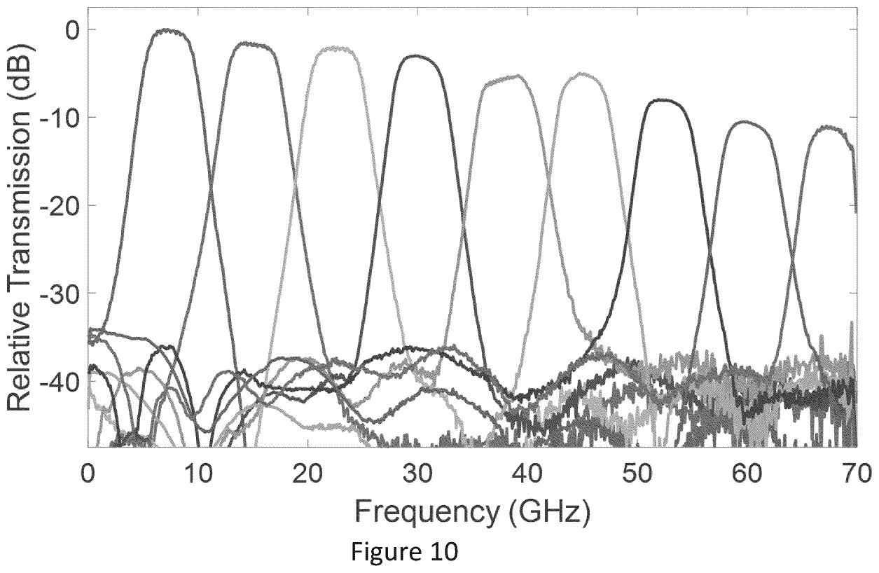

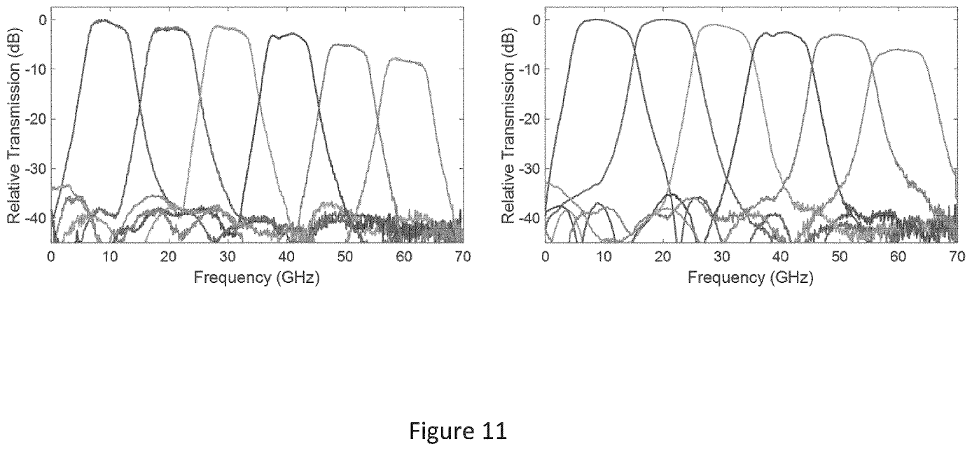

For the narrowest bandwidth tuning setting of the DFBR OF, the results relative to the tuning of the integrated MWP filter central frequency with 7.5 GHz steps are then shown in FIG. 10 (which shows the tuning of a 5 GHz-bandwidth integrated MWP filter central frequency in the range 7.5 -67.5 GHZ, for the case of DFBR tuning in the middle of the stopband), where the relative transmissions with respect to the normalized filter response for the lowest frequency tuning are displayed. The traces represent the measured RF power transfer function (squared magnitude of the S21 parameter from a vector network analyser, VNA) at different frequency offset between the input laser carrier and DFBR passband central frequency in the scheme of FIG. 1. The measured 6 dB bandwidth of the RF filter is around 5 GHz in this case, which is in accordance with the measured 3 dB optical bandwidth of the DFBR filter, considering that 1 dB drop in the optical filter response correspond to a 2 dB reduction in the RF power transmission of the system. For the cases of wider DFBR bandwidth (named Tuning 2 and Tuning 3 in FIG. 8 and FIG. 9) the corresponding MWP filter RF power transmission exhibits a −6 dB bandwidth of about 7.5 and 10 GHz. The results of experimental tuning of the central frequency over a nearly 70 GHz range are shown in FIG. 11. More specifically, FIG. 11 shows the results of tuning of the integrated MWP filter central frequency for the case of a 7.5 GHz-bandwidth (right plot of FIG. 11) and of 10 GHz-bandwidth filter (left plot) corresponding to the two different tuning of the DFBR passband window toward the shorter wavelength side of the stopband reported in FIG. 7 and FIG. 8. In the traces, the carrier-to-scanning sideband level at the PD input is adjusted through the variable optical splitter (VOS) for maximized OBPR, while keeping fixed the overall received power at 6 dBm using an optical variable attenuator.

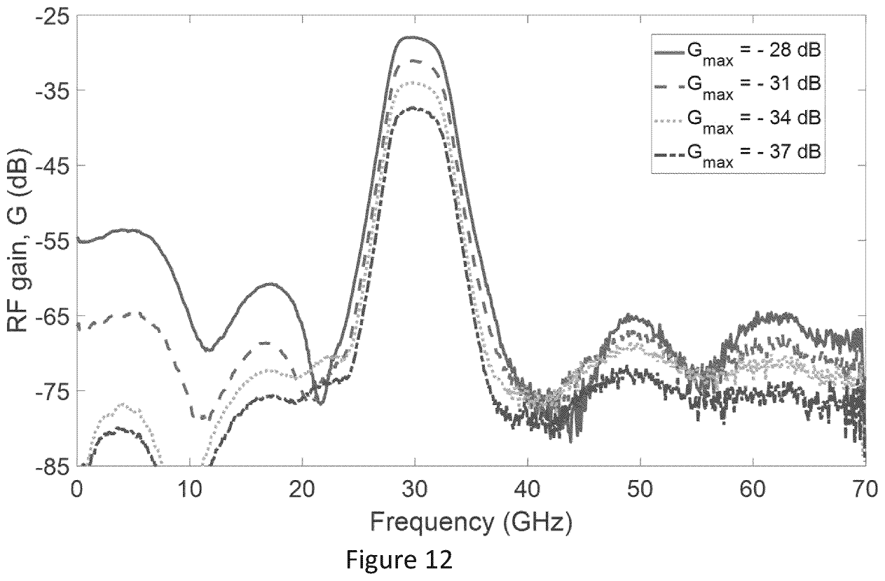

By acting on the VOS separating the input laser carrier after the optical input port of the PIC, the transmission characteristics of the MWP filter can indeed be finely adjusted, which might turn useful for shaping the filter performance for a desired target application. This is shown in FIG. 12 for the case of passband centred at 30 GHz in the traces of FIG. 10, where the RF gain of the system (i.e. the squared modulus of the measured S21 parameter) is measured for different levels of the carrier-to-scanning sideband power ratio at the PD input, for a fixed overall optical power of about 6 dBm. For the case in which a maximum RF gain, Gₘₐₓ, of −28 dB is obtained, a poor filter rejection at frequencies below about 20 GHz is observed. The full-span OBPR is correspondingly limited to about 26 dB. Nevertheless, between 20 and 70 GHz the OBPR stays well above 35 dB. As the value of Gₘₐₓ decreases, however, the suppression of spurious components in the low-frequency region sensibly improves. An optimal OBPR of 37 dB over the full 70 GHz span (as in the 30 GHz-centred trace of FIG. 10) is obtained when Gmax=−34 dB.

The limited OBPR behaviour at high RF gain is ascribed to the improved modulation efficiency of the equivalent MZI structure that is experienced by the residual optical components falling within the DFBR OF stopband. Since the modulator response is stronger between DC and about 20 GHz, the OSBR degradation is correspondingly larger in that range. On the other hand, in the high portion of the scanned spectrum, the measurement floor is mainly set by the different noise sources in the system. By acting on the MZI unbalance through the VOS for reducing the strength of the low frequency noisy terms originated by the beating between the optical carrier and spurious sideband components, it is this possible to extend the high OBPR frequency range at the only expense of a moderate RF gain reduction. This feature can be conveniently exploited for optimizing the selectivity and/or RF gain of the integrated MWP over specific operating frequency bands.

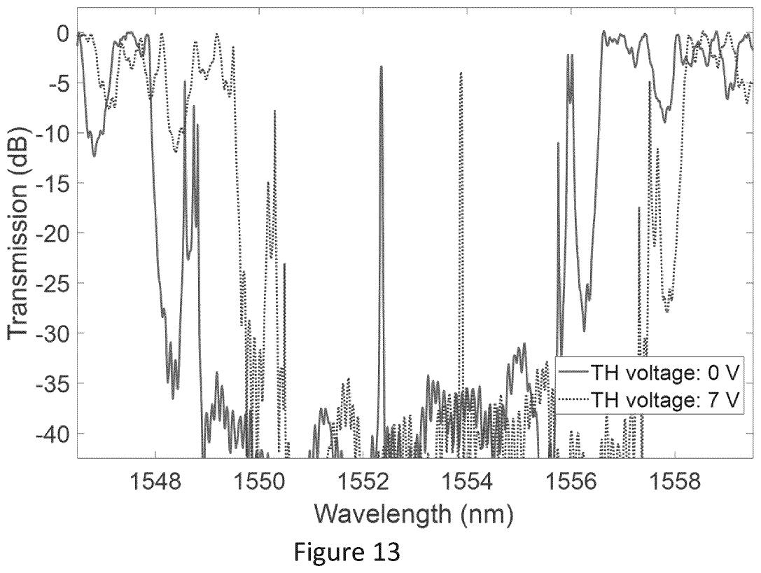

The possibility of independent central wavelength and bandwidth tuning for the DFBR OF provided by the micro heaters and general heater tuning mechanisms is then investigated. The results are shown in FIG. 13, where the wavelength of the passband window centred in the middle of the stopband is shifted by about 2 nm by applying a 7 V voltage control signal to the general heater (here named top heater, TH) with respect to the case in which no signal is applied to the general heater.

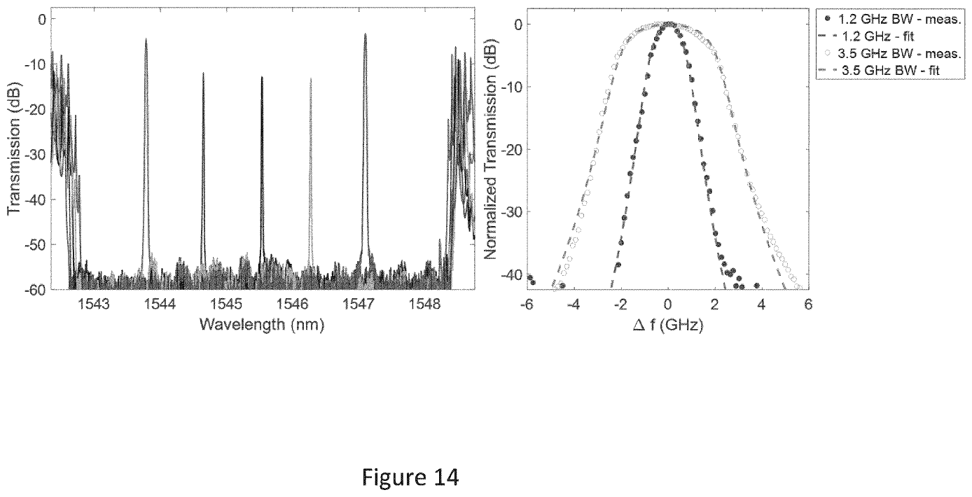

Bandwidth tuning from about 5 to 10 GHz has been observed with the above example device. Although wideband filters are of interest for band pre-selection in mm-wave receivers for high data-rate wireless communication or for wideband radar systems operating over multiple bands, smaller bandwidth values can be tailored in future designs for extending the application range of the proposed integrated MWP filter. By targeting tuneable bandwidth values ranging from few hundreds of MHz to few GHz, it would be possible to realize flexible channelizing (or pre-channelizing) operation in emerging mobile networks, allowing the compliance with the different communication standards and backward compatibility for radio front ends in future mobile networks. As an example, the results of a DFBR optical filter design allowing continuous bandwidth tuning between about 1 and 3 GHz are shown in FIG. 14. In FIG. 14, the example DFBR filter design provides bandwidth tuning in the 1-to-3 GHz range. Measured transmission for (left plot) wide wavelength span at different tuning positions of the passband and (right plot) corresponding details around passband central frequency corresponding to passband tuning at the centre (red dots) and at the edge (green dots) of the stopband.

Tuneable and bandwidth reconfigurable MWP filters may be incorporated into flexible wideband RF receivers, which in turn may be used in devices such as radio network nodes. A photonic integrated RF receiver may comprise a MWP filter as described in any of the above embodiments.

More specifically, in an embodiment, the photonic integrated RF receiver may further comprise a further electro-optical phase modulator; a local oscillator; and a tuneable optical filter. The photonic integrated RF receiver is configured such that: the further electro-optical phase modulator phase modulates the second optical portion based on a local oscillation signal from the local oscillator to generate an optical frequency comb; the tuneable optical filter selects a tone from the optical frequency comb having the frequency closest to a sideband signal output by the distributed feedback resonator structure; the tone and the sideband signal are recombined at the optical coupler to generate a composite signal; and the composite signal is converted to a filtered Intermediate Frequency, IF, signal at the photodiode.

In another embodiment, the photonic integrated RF receiver may further comprise a further electro-optical phase modulator; and a local oscillator. The photonic integrated RF receiver is configured such that: the further electro-optical phase modulator phase modulates the second optical portion based on a local oscillation signal from the local oscillator to generate an optical frequency comb; the optical frequency comb and a sideband signal output by the distributed feedback resonator structure are recombined at the optical coupler to generate a composite signal; and the composite signal is converted to a filtered Intermediate Frequency, IF, signal at the photodiode.

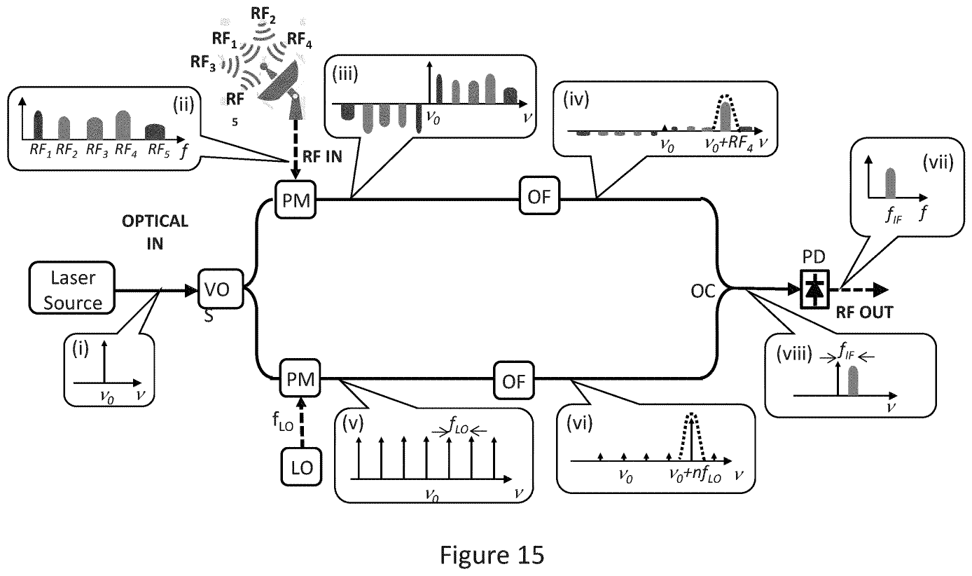

A wideband RF receiver 1500 in accordance with embodiments is shown schematically in FIG. 15. Relative to the FIG. 1D schematic, FIG. 15 shows a system updated by inserting an additional PM in the lower branch at the exit of the input VOS. As in the original scheme, the input laser carrier (i) is used to upconvert in the optical domain an incoming RF signal (ii), comprised by several channels centred around different RF carriers and occupying a certain bandwidth, through the PM in the upper branch (iii). After the PM, the central optical frequency and bandwidth of a tuneable and bandwidth-reconfigurable OF are set such to properly select a single channel replica in the generated double-sideband optical spectrum (iv). On the other hand, the PM in the lower branch is driven by a local oscillator LO at the frequency f_{LO}, with sufficiently large power to generate a comb of optical frequencies spaced by integer multiple of f_{LO} above and below the input laser carrier frequency vₒ (v). A following tuneable OF is then used to select from the comb the tone with the closest frequency to the selected RF channel optical-domain-replica in the upper branch (vi). The two signals at the output of the OFs in the upper and lower branch are then recombined in the OC and delivered to a PD (vii). After photodetection, the down-converted RF channel at the proper intermediate frequency (IF) f_{IF}=f_{RFx}−nf_{LO}, being f_{RFx} the carrier of the selected RF channel and n the order of the selected harmonic in the optical frequency comb (vii).

By changing the relative detuning between the input optical carrier and the OF on the upper branch, and acting on the bandwidth of the programmable OF, different RF channels with different bandwidth can be selected, whereas by selecting the proper comb tone with the tunable OF on the lower branch and/or acting on the LO frequency, the output IF value can be flexibly adjusted.

In embodiments such as that shown in FIG. 15, the OF after the PM in the lower branch may be omitted, as the bandwidth of the PD which is at the maximum intended f_{IF} is typically, although not necessarily, well below f_{LO}. In this case, the frequencies generated by the beating of the selected sideband portion in the upper branch and the optical comb emerging from the lower branch that lies outside the PD bandwidth are suppressed at the circuit output (a sufficiently wide RF low-pass filter can be additionally employed to further suppress residual spurious components). However, in this case, the average optical power impinging on the PD would be stronger than in the case of single tone-to-filtered sideband beating, which would possibly cause saturation of the PD, thus affecting the system linearity, and would additionally limit the available IF power at the output of the PD. These effects would be further exacerbated if optical amplification (either using an external amplifier or on-chip amplification available with hybrid III/V-SOI technology) would be used before photodetection. Thus, by selecting a single tone in the optical frequency comb after the PM in the lower branch, the saturation of the PD due the DC terms originated by self-beating of the comb tones would be avoided and output IF power can additionally be optimized.

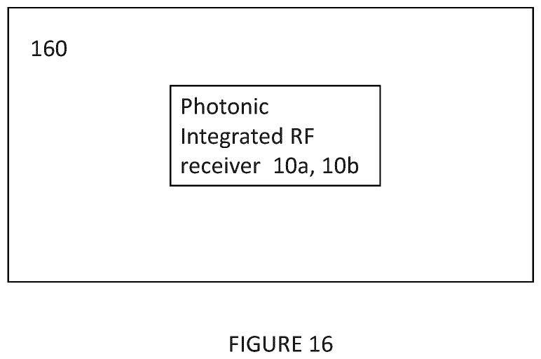

FIG. 16 is a schematic of a radio network node 160 comprising a photonic integrated RF receiver 1500 according to any of the described embodiments.

Embodiments provide photonic-based frequency-tuneable and bandwidth-programmable RF bandpass filter. In accordance with some embodiments, an input optical beam splitter with variable splitting ratio is used to create two replicas of an input optical carrier. One replica of the optical carrier enters a phase modulator to whose electrical input port is applied the RF signal to be filtered. An optical filter after the phase modulator selects a portion of one sideband from the modulated optical spectrum while strongly suppressing all the other spectral components at different frequencies from those occupied by the selected sideband portion. The optical filter central frequency and bandwidth may be continuously tuned. Two different tuning mechanisms are embodied within the OF structure to independently set its wavelength and bandwidth. The second replica of the optical carrier and the selected sideband portion are recombined through an optical beam coupler and delivered to a photodiode to generate the filtered version of the input RF signal. By changing the relative detuning between the input optical carrier frequency and the optical filter central frequency, the central frequency of the RF bandpass filter can be changed. By changing the bandwidth of the optical filter, the bandwidth of the RF filter is correspondingly changed. The relative detuning of the between the input optical carrier frequency and the optical filter can be changed by either acting on the input laser wavelength while changing the OF bandwidth using a single tuning mechanism or, keeping fixed the carrier wavelength, through the double tuning mechanisms that allows independent setting of the OF bandwidth and central wavelength, or a combination of the above methods. By acting on the splitting ratio of the input optical variable splitter, the RF filter performance can be finely adjusted to provide optimized rejection of the spurious components. By acting the splitting ratio of the input optical variable splitter, the rejection of the spurious components over some specific frequency range not of interest can be purposely diminished for the sake of improving the RF gain (i.e., output power of filtered RF signal) of the filter.

References in the present disclosure to “one embodiment”, “an embodiment” and so on, indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

It should be understood that, although the terms “first”, “second” and so on may be used herein to describe various elements, these elements should not be limited by these terms. These terms are only used to distinguish one element from another. For example, a first element could be termed a second element, and similarly, a second element could be termed a first element, without departing from the scope of the disclosure. As used herein, the term “and/or” includes any and all combinations of one or more of the associated listed terms.

The terminology used herein is for the purpose of describing particular embodiments only and is not intended to limit the present disclosure. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components, but do not preclude the presence or addition of one or more other features, elements, components /d/ or combinations thereof. The terms “connect”, “connects”, “connecting” and/or “connected” used herein cover the direct and/or indirect connection between two elements.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings.

1. A microwave photonic filter, MWP filter, for bandpass filtering, the MWP filter comprising:
a distributed feedback resonator structure comprising a first resonant cavity and a second resonant cavity, the distributed feedback resonator structure being configured such that an input optical signal is filtered by the first resonant cavity and second resonant cavity to generate a filtered output optical signal;
a first micro heater configured to adjust the temperature of the first resonant cavity;
a second micro heater configured to adjust the temperature of the second resonant cavity;
and at least one of:
a general heater configured to adjust the temperature of the distributed feedback resonator structure; and
a tuneable continuous wave laser source, wherein the MWP filter is configured to tune a wavelength of light generated by the tuneable continuous wave laser source and used by the MWP filter.

2. The MWP filter of claim 1, wherein the first resonant cavity and second resonant cavity are embedded between Bragg grating mirrors.

3. The MWP filter of claim 1, wherein the MWP filter is formed as a silicon-on-insulator photonic integrated circuit, or wherein the MWP filter is formed as a lithium niobate on insulator integrated circuit.

4. The MWP filter of claim 3, wherein the first micro heater and second micro heater are formed as resistive structures, and have separate input voltages from one another.

5. The MWP filter of claim 1, further comprising at least one further resonant cavity and corresponding further micro heater.

6. The MWP filter of claim 5, wherein the at least one further resonant cavity is positioned in series with the first resonant cavity and the second resonant cavity.

7. The MWP filter of claim 1, wherein the MWP filter bandwidth is programmable in a range between 500 MHz and 3 GHz.

8. The MWP filter of claim 1, further comprising:
an optical splitter;
an electro-optical phase modulator;
an optical coupler; and
a photodiode; and
wherein the MWP filter is configured such that:
an incident signal from a tuneable continuous wave laser source is split by the optical splitter to form first and second laser portions;
the first laser portion is phase modulated by the electro-optical phase modulator based on a received radio frequency, RF, signal, then filtered by the distributed feedback resonator structure to generate a sideband signal;
the sideband signal and second laser portion are recombined at the optical coupler to generate a composite signal; and
the composite signal is converted to a filtered RF signal at the photodiode.

9. The MWP filter of claim 8, wherein the MWP filter is configured to tune the tuneable continuous wave laser with reference to the temperature adjustments provided by the first micro heater and a second micro heater.

10. The MWP filter of claim 9, wherein the RF signal is an Intermediate Frequency, IF, signal.

11. A photonic integrated RF receiver comprising microwave photonic filter, the MWP filter comprising:
a distributed feedback resonator structure comprising a first resonant cavity and a second resonant cavity, the distributed feedback resonator structure being configured such that an input optical signal is filtered by the first resonant cavity and second resonant cavity to generate a filtered output optical signal;
a first micro heater configured to adjust the temperature of the first resonant cavity;
a second micro heater configured to adjust the temperature of the second resonant cavity; and at least one of:
a general heater configured to adjust the temperature of the distributed feedback resonator structure; and
a tuneable continuous wave laser source, wherein the MWP filter is configured to tune a wavelength of light generated by the tuneable continuous wave laser source and used by the MWP filter.

12. The photonic integrated RF receiver of claim 11, wherein the photonic integrated RF receiver is comprised in a radio network node.

13. A method for bandpass filtering using a microwave photonic, MWP, filter, the method comprising:
tuning a bandwidth of the MWP filter by adjusting the temperature of a first resonant cavity of a distributed feedback resonator structure using a first micro heater, and adjusting the temperature of a second resonant cavity of the distributed feedback resonator structure using a second micro heater;
tuning the central frequency of the MWP filter by at least one of:
adjusting the temperature of the distributed feedback resonator structure using a general heater; and
tuning a wavelength of light generated by a tuneable continuous wave laser source and used by the MWP filter; and
filtering an optical signal using the tuned MWP filter.

14. A method according to claim 13, further comprising:
receiving a radio frequency, RF, signal, and upconverting the RF signal into an optical signal; and
filtering the optical signal used the tuned MWP filter.

15. The MWP filter of claim 2, wherein the MWP filter is formed as a silicon-on-insulator photonic integrated circuit, or wherein the MWP filter is formed as a lithium niobate on insulator integrated circuit.

16. The MWP filter of claim 15, wherein the first micro heater and second micro heater are formed as resistive structures, and have separate input voltages from one another.

17. The MWP filter of claim 2, further comprising at least one further resonant cavity and corresponding further micro heater.

18. The MWP filter of claim 17, wherein the at least one further resonant cavity is positioned in series with the first resonant cavity and the second resonant cavity.

19. The MWP filter of claim 2, wherein the MWP filter bandwidth is programmable in a range between 500 MHz and 3 GHZ.

20. The MWP filter of claim 2, further comprising:
an optical splitter;
an electro-optical phase modulator;
an optical coupler; and
a photodiode; and
wherein the MWP filter is configured such that:
an incident signal from a tuneable continuous wave laser source is split by the optical splitter to form first and second laser portions;
the first laser portion is phase modulated by the electro-optical phase modulator based on a received radio frequency, RF, signal, then filtered by the distributed feedback resonator structure to generate a sideband signal;
the sideband signal and second laser portion are recombined at the optical coupler to generate a composite signal; and
the composite signal is converted to a filtered RF signal at the photodiode.
